(19) United States
(12) Patent Application Publication
(10) Pub. No.: US 2005/0081891 A1
(43) Pub. Date: Apr. 21, 2005

(54) Removing dust using a hand pump

(76) Inventor: Ray Arjomand, New York, NY (US)

Correspondence Address: RAY ARJOMAND, 570 Isham Street, #3E, New York, NY, 10034, US

(21) Appl. No.: 10/961,603

(22) Filed: Oct. 12, 2004

Related U.S. Application Data
(60) Provisional application No. 60/511,156, filed on Oct. 14, 2003.

(51) Int. Cl. B08B 5/04

(52) U.S. Cl. 134/21; 15/341; 134/34

(57) ABSTRACT

A hand pump capable of blowing air out of the pump or sucking air into the pump is used to clean dust and debris from electrical equipment. The dust may be blown away from the equipment by the force of air exiting from the pump or may be vacuumed into a dust-collecting compartment on the pump.

### CROSS REFERENCE TO RELATED APPLICATIONS

This case corresponds in subject matter to Disclosure Document No. 535537, entitled “Manual Air Pump For Removing Dust”, dated Jul. 28, 2003 and relies on the filing date of Oct. 14, 2003 for Provisional Application Ser. No. 60/511,156.

### BACKGROUND OF THE INVENTION

1) Field of the Invention

The present invention generally relates to a method of using a manual air pump for removing dust. It is a method or process for removing dust or debris using a manual hand air pump.

2) Description of the Related Art

The manual air pump has not traditionally been thought of as a device for removing dust. The non-electric air pump is a mature technology, as old as bicycle tire. There are many different styles, makes, and models of manual air pumps, and there is no need to re-invent them in this application.

Every day, millions of Condensed Air Cans (an aerosol-type device for removing dust) are sold on the internet and in office supply, computer, and hardware stores. Consumers use air cans to remove dust from computer, video, photographic and other sensitive equipment. At a cost of approximately $6 per can, it is an expensive item. Once used, these empty cans are thrown into landfills, wasting natural resources and damaging the environment.

U.S. Pat. No. 5,335,703 entitled “Rechargeable Dust-off Device And Method Of Using The Device” discloses a rechargeable air can. The device may be repetitively filled with compressed air using a valve which allows a bike pump or gas station pump to fill the device. Alternatively, a built-in pump connected to an inlet valve in the chamber may be implemented for introducing compressed air into the device. U.S. Pat. No. 4,874,404, entitled “Vacuum Cleaner,” features an Electric Vacuum Cleaner that uses water to filter out and remove dust. U.S. Pat. No. 5,531,722, entitled “Aspiration Unit,” applies to a device connected to an ultrasonic scaler that includes a novel suction device for carrying water and debris generated during scaling procedures away from a work site. U.S. Pat. No. 2,968,441, entitled “Spray Nozzle Assembly for Use with Aerosol Can,” covers a nozzle assembly and attachment that allows the user to spray directly and accurately on a location that is unavoidably separated from the can by various objects and structures. U.S. Pat. No. 5,989,360 entitled “Gas-Driven Portable Self-contained Vacuum Device,” features an attachment to a condensed air can that converts it into a vacuum device.

Electronic equipment such as computers, telephones, faxes, printers, and copiers gather dust over time. The dust creates a thermal blanket that damages sensitive equipment. Other devices such as computer keyboards, electric shavers, drapes, telephones also gather dust and debris. Condensed air cans are presently used to remove the dust and dirt from the equipment by blowing it away.

Electrical vacuums either plug into wall outlets or are powered by batteries. Although electrical floor vacuums are very good for cleaning large rooms and rugs, they are not good for removing dust from sensitive electronic equipment. That is why millions of people buy air cans every day.

Some of the advantages of a hand pump over an electrical vacuum or pump are:
1. A hand pump requires no electrical wire or batteries.
2. A hand pump can provide a much stronger jolt of air than battery powered vacuum.
3. A hand pump is less expensive to manufacture because it has no electrical components.
4. An electrical floor vacuum is too bulky and powerful for sensitive equipment. It can damage the equipment by sucking the chips or loose screws.
5. Using the bulky floor vacuum is time-consuming and requires more energy.

For these reasons, millions of people buy air cans every day. Using the air can, however, has the following disadvantages:
1. It is expensive.
2. It runs out quickly.
3. Empty cans are thrown into landfills, creating pollution.
4. It wastes limited natural resources (aluminum and other raw materials).
5. It may explode if heated. It is flammable.
6. Often, it ejects cold liquid instead of dry air as it is supposed to do. This could damage sensitive equipment.

### BRIEF SUMMARY OF THE INVENTION

This invention is a method or process for removing dust or debris using a manual hand air pump. It is particularly useful for removing dust and debris from sensitive electronic equipment. Presently condensed air cans are primarily used for removing dust from equipment. A high quality hand pump (approximately 1′ long and 3″ in diameter) may cost more than two condensed air cans, but it will last for many years. It is a “user friendly” device that requires no batteries or electricity. Since the user is not inflating anything (ball, bed, tire, etc.) and is only blowing air into space (to remove dust), it requires very little energy to operate.

The hand pump generates a stronger jolt of air than is possible for any air can, and unlike the can, it never ejects cold liquid. Since it is re-usable, it is a lot cheaper than the air cans and does not pose waste disposal problems. The consumer saves money, gets a better product that lasts a lot longer and does not harm the environment.

Air pumps are used for blowing air into bicycle tires or inflatable boats, balls, beds and other inflatable objects. Since there are thousands of different shapes and forms of air pumps on the market, it is not feasible or necessary to include (re-invent) this old technology in this application.

The hand pump can remove dust either by blowing it away or by sucking it into the pump (manual vacuum cleaner). The hand pump provides an inexpensive alternative to air can. The hand pump has the following advantages over the air can:
1. Unlike the air can, a high quality hand pump can last many years.
2. Since it lasts a long time, it does not pollute the environment.
3. Although the price of a hand pump may initially be higher than the cost of a single air can, it is cheaper in the long run because it provides many years of service.
4. The user has control over the air pressure created by the hand pump.
5. A hand pump never ejects cold liquid into sensitive equipment like the air cans do.
6. Since the user is not inflating anything (ball, bed, tire, etc.) and is only blowing air into space (to remove dust), the hand pump requires very little energy to operate, yet provide a much stronger jolt of air than the air can.
7. The pumping action provides a good hand exercise while cleaning.
8. In an alternative embodiment, a hand pump may be multi-functional. It may have a nozzle that can be replaced with another nozzle to inflate balls, tires, beds and other objects, like the Swiss army knife concept.

Below are drawings to demonstrate a hand pump used mainly for removing dust and debris. It should be understood that the description and drawings disclose specific embodiments and are for purposes of illustration only. There my be other modifications and changes obvious to those of ordinary skill in the art which fall within the scope of the present invention. For example the hand pump may have a different form or shape from illustrations below. Since there are hundreds of different shapes and models of manual pumps on the market today, one cannot incorporate all of them in this application-reinventing the wheel. The shape or form of the manual hand pump is not the subject of this invention, but its use for removing dust and debris is.

### BRIEF DESCRIPTION OF THE DRAWINGS

FIG. 1. shows a manual air pump used for removing dust.

FIG. 2. shows an embodiment of a manual air pump with piston moving down pressing air out.

FIG. 3. shows an embodiment of a manual air pump with the piston moving up and filling the cylinder with air.

FIG. 4 shows an embodiment of a manual vacuum pump with the piston moving up and filling the cylinder with air.

FIG. 5. shows a manual vacuum pump with the piston moving down pressing the air out of cylinder.

FIG. 6 shows a manual vacuum pump having a dust container and anti-static wire attachment.

FIG. 7 is a flexible plastic hand pump suitable for use in this invention.

### DETAILED DESCRIPTION OF THE INVENTION

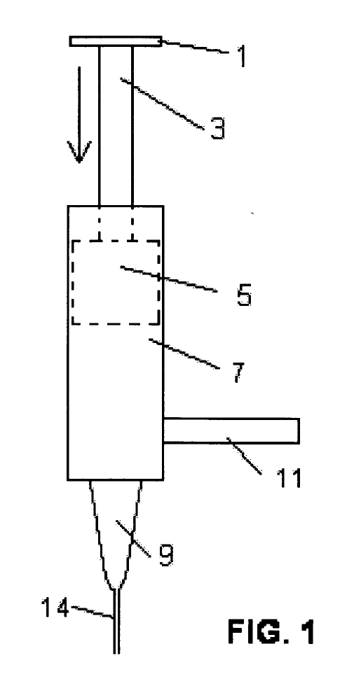

FIG. 1 is an example of a manual air pump for removing dust. The air pump has two handles (1 and 11). Handle 1 is attached to a bar 3 that is attached to a piston 5. The piston 5 moves within the cylinder 7. The pump has preferably a non-flexible neck or nozzle 9 to direct the air flow. Handle 11 is securely attached to the body of the pump to facilitate holding of the pump with one hand.

In operation, the user holds the pump with one hand using handle 11, and with the other hand presses handle 1 into the direction of the cylinder 7. That forces piston 5 to move within the cylinder 7 forcing the air out of nozzle 9. The nozzle 9 can have a standard size opening to allow a standard plastic straw 14 to be inserted therein. This will allow the air output to be directed at the desired spot.

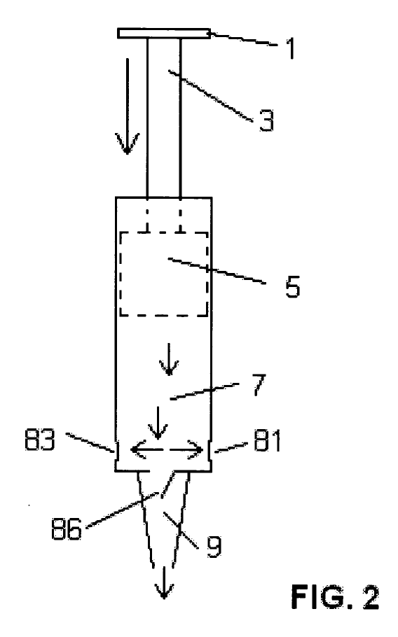

FIG. 2 shows a hand pump similar to that shown in FIG. 1, but without handle 11 and with three additional gates/valves (81, 83, and 86) that open in only one direction. The user pushes the handle 1 attached to bar 3 into the cylinder 7. As the piston 5 moves down and forces the air in the direction shown, the rising air pressure inside the cylinder 7 forces valves 81 and 83 to close and prevent the air from escaping outside of the cylinder 7. Simultaneously, the air pressure inside the cylinder 7 forces the valve 86 to open allowing air to eject out of the nozzle 9 in the direction indicated by the arrow.

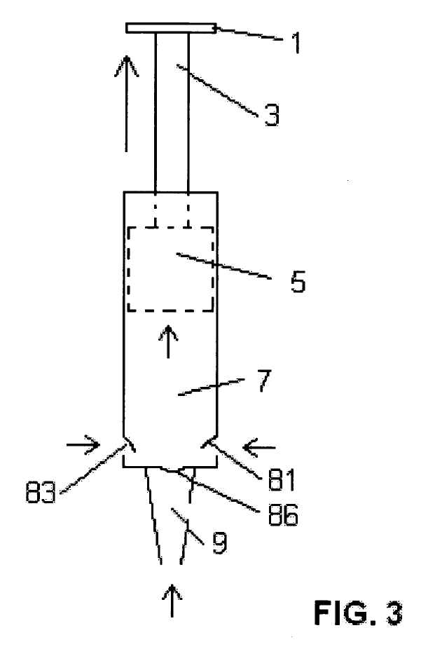

In FIG. 3 the reverse of what occurs in FIG. 2 happens. The user pulls the handle 1 attached to bar 3 out. As the piston 5 moves up inside the cylinder 7, it creates a vacuum inside the cylinder 7. The outside pressure forces the gates 81 & 83 to open, letting air into the cylinder 7. Simultaneously, the outside pressure forces gate 86 to close, thereby preventing the air from moving into the cylinder 7 from the nozzle 9.

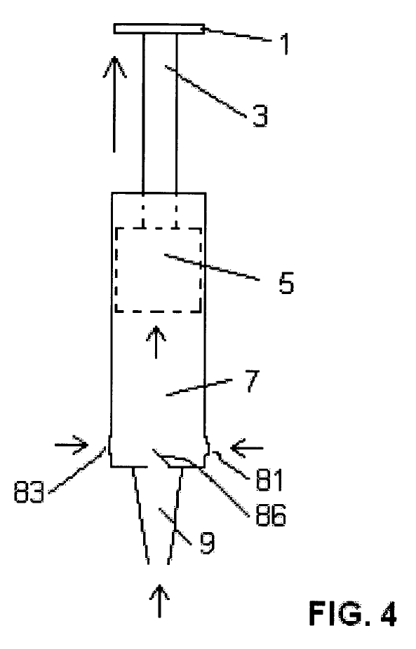

FIG. 4 is an embodiment of a manual vacuum pump with three gates (valves) that open in only one direction (gates 81, 83, and 86). The user pulls the handle 1 attached to bar 3 out. As the piston 5 moves up the cylinder 7, it creates a vacuum inside the cylinder 7. The outside air pressure forces the gates 81 & 83 to close, preventing outside air from entering the cylinder 7. Simultaneously, the outside air pressure forces gate 86 to open, thereby letting the outside air into the cylinder 7 from the nozzle 9 opening (vacuum the dust/debris into the cylinder 7).

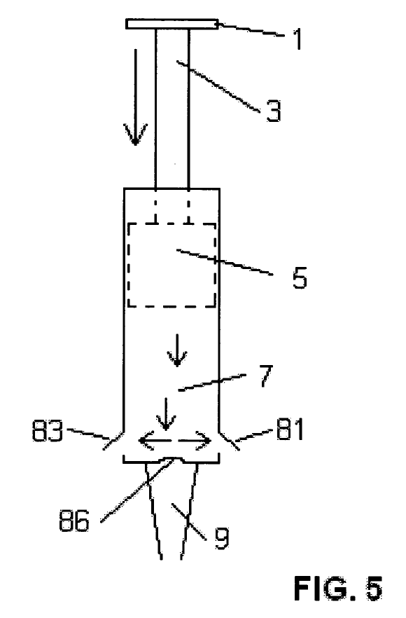

FIG. 5 is similar to FIG. 4 except that reverse of what occurs in FIG. 4 happens. As the piston 5 is forced down the cylinder 7, it creates high pressure inside the cylinder 7. The high pressure inside the cylinder 7 forces the gates 81 & 83 to open, letting air (dust/debris) out of the cylinder 7. Simultaneously, the high air pressure forces gate 86 to close, preventing the air from escaping through the nozzle 9 opening.

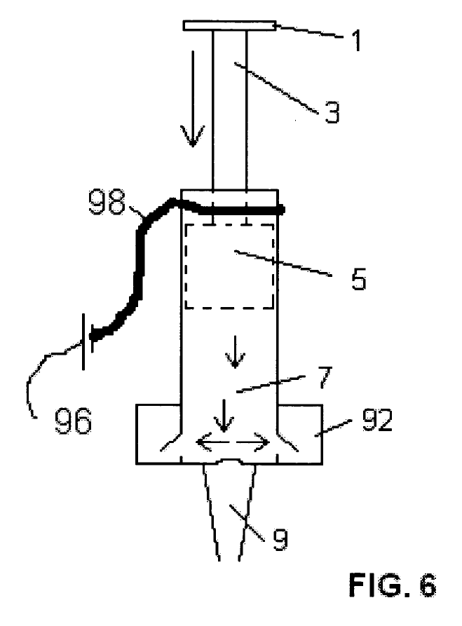

FIG. 6 is similar to FIG. 5 except that it has a dust container 92 surrounding gates 81 & 83 to prevent the dust from blowing outside of the cylinder 7 into the room. It collects the dust and debris. The container 92 has a filter that collects the dust while allowing the air to escape. In addition the pump of FIG. 6 has an optional anti-static conductive wire or band 98 attached to a local ground source 96. The anti-static wire 98 may be permanently attached to a metallic conductive part of the pump. The purpose of the anti-static wire 98 is to discharge any static electricity that may be present in the pump. Static electricity damages electronic equipment. This prevents any damage to the equipment caused by static electricity. In this instance the pump is made from metallic substance that has a static discharge wire permanently attached to it to prevent and reduce the possibility of damage caused by static electricity.

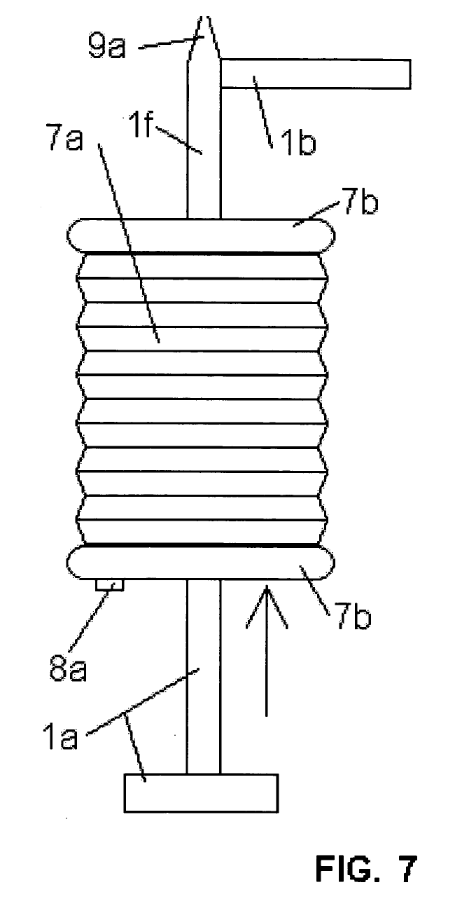

FIG. 7 is a drawing of a flexible plastic pump. It has been modified/enhanced to be used for removing dust. The pump is made of plastic and has two non-flexible ends 7b that sandwich the flexible central part 7a. The central plastic section 7a expands and contracts by force of hand. The pump has two end handles 1a and 1b. 1b is attached to a neck portion If which is hollow to allow the air to pass through it. It has a nozzle 9a at the end to direct the air flow.

The user holds the pump with the two handles 1a and 1b and squeezes the pump by force. Since the user blows the air into space to remove dust (not inflating anything) it requires very little energy. The air is forced out of the pump through the nozzle 9a in the direction shown. Then the user pulls the two handles apart to force air back into the pump and expand the flexible central component 7a. Optionally, the pump may have an air-inlet valve/gate 8a. The valve 8a only allows the air into the pump one way. No air can exit the pump through the valve 8a. The pump may also have a valve in the neck portion If (not shown) that only allows air to exit the nozzle 9a one way. The valve will close to prevent air from getting into the pump through the nozzle 9a.

In performing the method of the present invention, the nozzle 9a of the pump may be directed at the area to be cleaned. In one instance, where the pump acts as a blower, the handle 1 is pushed forward to expel air and remove the dust. In another instance, where the pump acts as a vacuum, the handle 1 is pulled back and the dust enters the pump.

1. A method which removes dust and debris from electrical equipment, which method comprises providing a hand pump having a handle, a cylinder, and a nozzle, directing the nozzle of the hand pump toward the dust and debris to be removed, manipulating the handle of the hand pump so as to create either a blowing of air out of the nozzle or a sucking in of air into the cylinder.

2. The method of claim 1, wherein the handle is manipulated so as to create air being blown from the nozzle.

3. The method of claim 1, wherein the handle is manipulated so that air is sucked into the cylinder of the hand pump.

4. The method of claim 1, wherein the hand pump contains an anti-static wire.

5. The method of claim 3, wherein the hand pump has a) a central valve which allows air into the hand pump when handle is pulled back but does not allow air to pass from the cylinder to the nozzle, b) a dust collection container having a filter outside of the hand pump, and c) a plurality of valves which allow the air to pass from the cylinder to the dust container when the handle is pushed forward.

6. A hand pump having a handle, a cylinder, and a nozzle wherein the hand pump has a) a central valve which allows air into the hand pump when handle is pulled back but does not allow air to pass from the cylinder to the nozzle, b) a dust collection container having a filter outside of the hand pump, and c) a plurality of valves which allow air to pass from the cylinder to the dust container when the handle is pushed forward.
